(19) United States
(12) Patent Application Publication
(10) Pub. No.: US 2021/0270219 A1
(43) Pub. Date: Sep. 2, 2021

(54) PUMP FOR INTERNAL COMBUSTION ENGINE AND METHOD OF FORMING SAME

(71) Applicant: NOSTRUM ENERGY PTE. LTD., Singapore (SG)

(72) Inventors: Frank S. LOSCRUDATO, Ann Arbor, MI (US); Osanan Barros NETO, Ann Arbor, MI (US); Naag PIDURU, Ann Arbor, MI (US)

(73) Assignee: NOSTRUM ENERGY PTE. LTD., Sinagpore (SG)

(21) Appl. No.: 17/324,026

(22) Filed: May 18, 2021

Related U.S. Application Data
(63) Continuation of application No. 16/353,480, filed on Mar. 14, 2019.
(60) Provisional application No. 62/642,949, filed on Mar. 14, 2018.

(51) Int. Cl. F02M 37/00; F02M 59/48; F02M 55/00; F02M 55/04

(52) U.S. Cl. CPC F02M 37/0017; F02M 55/04; F02M 55/005; F02M 59/48

(57) ABSTRACT

A high pressure fuel pump used for an internal combustion engine and a related method are provided. The fuel pump has a body having a top surface and a side surface. A damper housing is provided on the top surface. A damper cover is provided on the damper housing. A top engaging structure of the damper housing and a bottom engaging structure of the damper cover operatively engage each other to connect the damper cover to the damper housing in a sealed manner. The damper cover and the damper housing collectively define a space for accommodating one or more fluid pressure dampers. A fuel is introduced into the fuel pump through a fuel inlet fitting and processed by the fluid pressure dampers to increase the pressure of the fuel. The fuel of increased pressure is released through a fuel outlet fitting of the fuel pump.

### CROSS REFERENCE TO RELATED APPLICATIONS

The present application is a continuation of U.S. application Ser. No. 16/353,480, filed Mar. 14, 2019, which claims priority to and the benefit of U.S. App. No. 62/642,949, filed Mar. 14, 2018, the entire contents of each of which are hereby incorporated by reference in their entirety.

### FIELD OF THE DISCLOSURE

The present disclosure relates to a pump and a method of making the pump. More particularly, the present disclosure relates to modifying a conventional high pressure gasoline fuel pump (e.g., an original equipment high pressure fuel pump) to provide a high pressure fuel pump, which can be used in internal combustion engines for delivering fuel directly into combustion chambers of the engines.

### BACKGROUND

The known methodologies for modifying original equipment fuel pumps present several problems. The excessive machining of the original equipment fuel pump body results in high contamination risk and high reject rates from machining errors as well as risk of failure due to the weakening of the core pump body of the original equipment high pressure fuel pump. The common computer numeric control (CNC) machined quadratic damper housings employed by alternate methodologies require a rubber sealing ring to contain fluid inside the damper housing, which ring seals have been prone to leaking and yield a high reject rate due to assembly errors. The prevalent method of assembly of the quadratic damper housing is by employing two or more fasteners, which fasteners require threaded holes in the original equipment high pressure fuel pump body. The fastening methodologies are subject to assembly quality errors and in-field risk of torque decay, resulting in potential leaks or damper housing failure, in addition to requiring high complexity in manufacturing. Additionally, conventional methods employ low pressure fuel fittings that are threaded to the damper housing, which fittings may utilize a thread seal or may employ a sealing ring. This method of low pressure fitting feature results in an excessive packaging dimension in addition to presenting alternate fluid leak paths and failure potential.

Therefore, there is a need for improved fuel pumps, which are retrofittable and can be used for different applications. The method and device of the present disclosure aim to eliminate the above-discussed drawbacks of the conventional methodology for modifying an original equipment high pressure fuel pump.

### SUMMARY

According to an exemplary aspect of the present disclosure, a fuel pump is provided. The fuel pump includes a body having a top surface and a side surface. The top surface and the side surface are angular with respect to each other. The fuel pump further includes a damper housing provided on the top surface. The damper housing includes a substantially cylindrical wall extending vertically from the top surface along a vertical axis of the substantially cylindrical wall. The fuel pump also includes a damper cover provided on the damper housing. The damper cover includes a substantially cylindrical wall extending co-axially along the vertical axis. The damper housing includes a top engaging structure and the damper cover includes a bottom engaging structure. The top engaging structure and the bottom engaging structure operatively engage each other to connect the damper cover to the damper housing in a sealed manner. The damper cover and the damper housing collectively define a space for accommodating at least one fluid pressure damper. The fuel pump additionally includes a fuel inlet fitting through which a predetermined fuel enters the fuel pump. The fuel inlet fitting is substantially cylindrical and insertable into an opening of the damper cover in a sealed manner. The fuel pump additionally includes a fuel outlet fitting. The fuel outlet fitting is substantially cylindrical and is insertable into an opening of the side surface of the body in a sealed manner. The predetermined fuel is processed by the at least one fluid pressure damper to increase the pressure of the predetermined fuel and wherein the predetermined fuel of the increased pressure is released through the fuel outlet fitting.

According to another exemplary aspect of the present disclosure, a method of forming a fuel pump is provided. According to the method, a body having a top surface and a side surface is provided, wherein the top surface and the side surface are angular with respect to each other. A damper housing is provided on the top surface, wherein the damper housing comprises a substantially cylindrical wall extending vertically from the top surface along a vertical axis of the substantially cylindrical wall. A damper cover is provided on the damper housing, wherein the damper cover comprises a substantially cylindrical wall extending co-axially along the vertical axis, wherein the damper housing comprises a top engaging structure and the damper cover comprises a bottom engaging structure, wherein the top engaging structure and the bottom engaging structure operatively engage each other to connect the damper cover to the damper housing in a sealed manner, wherein the damper cover and the damper housing collectively define a space for accommodating at least one fluid pressure damper. A fuel inlet fitting is inserted into an opening of the damper cover in a sealed manner, wherein a predetermined fuel enters the fuel pump through the fuel inlet fitting, wherein the fuel inlet fitting is substantially cylindrical. A fuel outlet fitting is inserted into an opening of the side surface of the body in a sealed manner, wherein the fuel outlet fitting is substantially cylindrical. The predetermined fuel is processed by the at least one fluid pressure damper to increase the pressure of the predetermined fuel and the predetermined fuel of the increased pressure is released through the fuel outlet fitting.

### BRIEF DESCRIPTION OF THE DRAWINGS

FIG. 1 is a perspective view of a high pressure fuel pump according to an exemplary embodiment of the present disclosure;

FIG. 2 is a front elevation view of the pump shown in FIG. 1;

FIG. 3 is a sectional view of the pump shown in FIG. 1;

FIG. 4 is a perspective view of a pump body and a damper housing of the pump shown in FIG. 1;

FIG. 5 is a sectional view of the pump body and the damper housing of FIG. 4;

FIG. 6 is a perspective view of a damper cover of the pump shown in FIG. 1;

FIG. 7 is a sectional view of the damper cover of FIG. 6;

FIG. 8 is a perspective view of a high pressure fuel pump according to another exemplary embodiment of the present disclosure;

FIG. 9 is a perspective view of a high pressure fuel pump according to yet another exemplary embodiment of the present disclosure; and

FIG. 10 is a perspective view of a high pressure fuel pump according to still another exemplary embodiment of the present disclosure.

### DETAILED DESCRIPTION OF EXEMPLARY EMBODIMENTS

Detailed embodiments of the present disclosure are described herein; however, it is to be understood that the disclosed embodiments are merely illustrative of the compositions, structures and methods of the disclosure that may be embodied in various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the compositions, structures and methods disclosed herein. References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment.

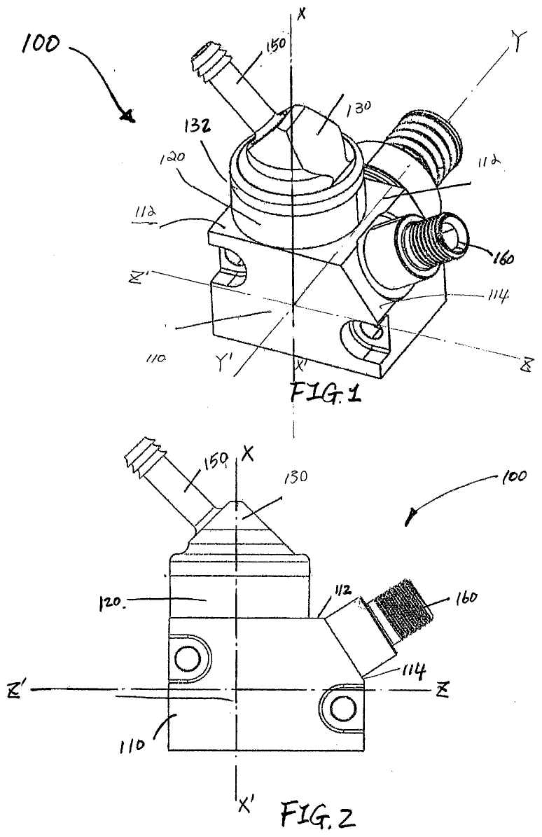

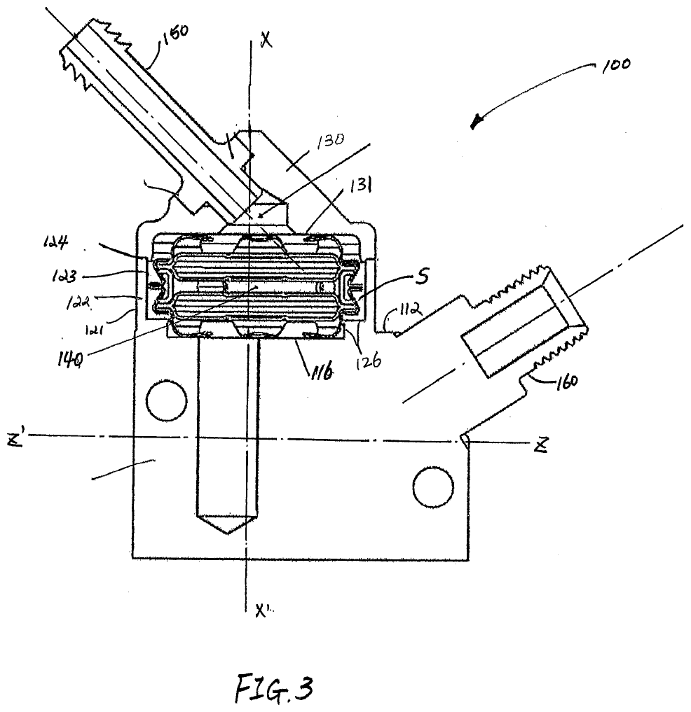

FIG. 1 is a perspective view of a high pressure fuel pump 100 according to an exemplary embodiment of the present disclosure. FIG. 2 is a front elevation view of the high pressure fuel pump 100. FIG. 3 is a sectional view of the high pressure fuel pump 100. In the high pressure fuel pump 100 as shown, certain known parts, components and structures have been omitted for the purpose of brevity.

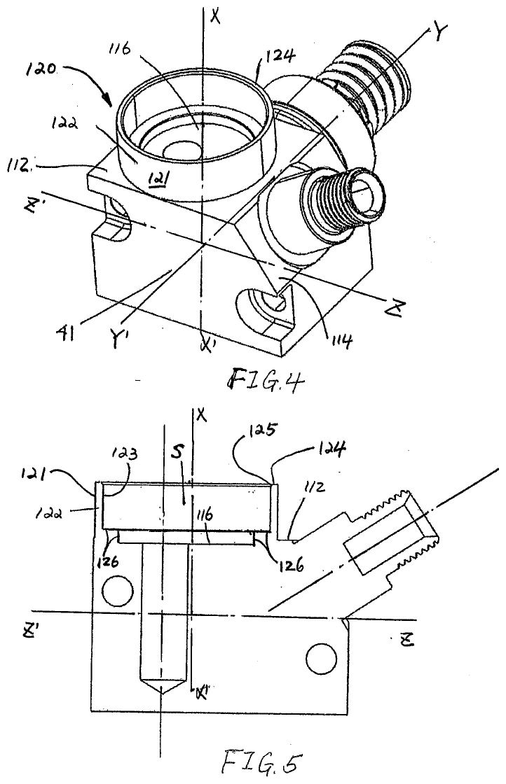

As shown in FIGS. 1-3, the high pressure fuel pump 100 includes a pump body 110, which can be similar or the same as the pump body of a known high pressure fuel pump. The pump body 110 has a top surface 112 and a side surface 114, which are formed angularly with respect to each other. The high pressure fuel pump 100 further includes a damper housing 120 extending upwardly and substantially vertically from the top surface 112 of the pump body 110. The damper housing 120 includes a substantially cylindrical wall extending axially along a vertical axis XX′ that extends substantially vertically to the top surface 112 of the pump body 110. The detailed structure of the damper housing will be described later with reference to FIGS. 4 and 5. In FIG. 1, a three-dimensional coordinate system is defined as shown. The fuel pump 100 has a height extending along the vertical axis XX′ of the coordinate system, a length extending along a longitudinal axis ZZ,′ and a width extending along a lateral axis YY′.

The high pressure fuel pump 100 further includes a damper cover 130, which can be coupled or assembled to the damper housing 120. The damper cover 130 includes a substantially cylindrical wall 132 (which is shown in FIG. 7), which extends co-axially along the vertical axis XX′. The damper housing 120 and the damper cover 130 can be press-fitted or mechanically bonded to each other through respective mating structures provided to the damper housing 120 and the damper cover 130, respectively. Alternatively or additionally, the damper housing 120 and the damper cover 130 can be welded to each other along the circumference of the cylindrical wall 132 of the damper cover 130.

Once the damper cover 130 is assembled or coupled to the damper housing 120, a receiving space S is formed by an inner surface of the damper cover 130, a lower inner surface of the damper housing 120, and an inner surface 116 at the top of the pump body 110. A fluid pressure damper 140 or multiple same or similar fluid pressure dampers can be retained or entrapped in the receiving space, which is best shown in FIG. 3.

The high pressure fuel pump 100 includes a fuel inlet fitting 150, which can be substantially cylindrical. The fuel inlet fitting 150 is provided upstream of the fuel circuit and can be pressed and/or mechanically bonded to the damper cover 130. In the shown embodiment, the fuel inlet fitting 150 is a barb style fuel line fitting having a diameter of about 8 mm. The inlet fuel fitting 150 is at an angle with respect to the top surface 112 of the pump body 110. In the shown embodiment, the angle is about 45 degrees. The angle can be in a range of about 0 degrees to about 90 degrees with respect to surface 112. For example, the angle can be in a range of about 0 degrees to about 45 degrees. For example, the angle can be in a range of about 46 degrees to about 90 degrees.

The high pressure fuel pump 100 further includes a high pressure fuel outlet fitting 160, which can be substantially cylindrical and is provided on the slanted side surface 114 of the pump body 110. When viewed from a top of the high pressure fuel pump 100 in the direction of the axis XX′, the fuel inlet fitting 150 and the high pressure fuel outlet fitting 160 forms an angle of about 180 degrees circumferentially with respect to the axis XX′. The angle formed by the fuel inlet fitting 150 and the high pressure fuel outlet fitting 160 can be in a range of about 0 degrees to about 360 degrees circumferentially with respect to the axis XX′.

As shown in FIGS. 4 and 5, the damper housing 120 includes a substantially cylindrical wall 122 axially symmetrical with respect to the axis XX′. The cylindrical wall 122 is circumferentially continuous and includes an outer surface 121 and a radially opposite inner surface 123. The cylindrical wall 122 further includes a top engaging surface 124, which is substantially parallel to the top surface 112 of the pump body 110. The top engaging surface 124 is continuous to an inwardly tapered surface 125. The inwardly tapered surface 125 connects the top engaging surface 124 to the inner surface 123 of the cylindrical wall 122. The top engaging surface 124 and the inwardly tapered surface 125 can be formed by machining, cutting or sectioning the top portion of a known damper housing. The dimensions of the top engaging surface 124 and the inwardly tapered surface 125 can be customized to be suitable for different applications. The damper receiving space S has a volume, which is defined by the diameter of the cylindrical wall 122 and the distance between the top engaging surface 124 of the damper housing 120 and the top surface 112 of the pump body 110. For example, the damper receiving space S is defined by the inner surface 123 of the cylindrical wall 122, a stepped surface 126 of the cylindrical wall 122, and the inner top surface 116 of the pump body 110. The stepped surface 126 and the inner top surface 116 can be the same or similar to a known high pressure fuel pump and as a result, the known pump can be reused or reengineered to be suitable for different applications.

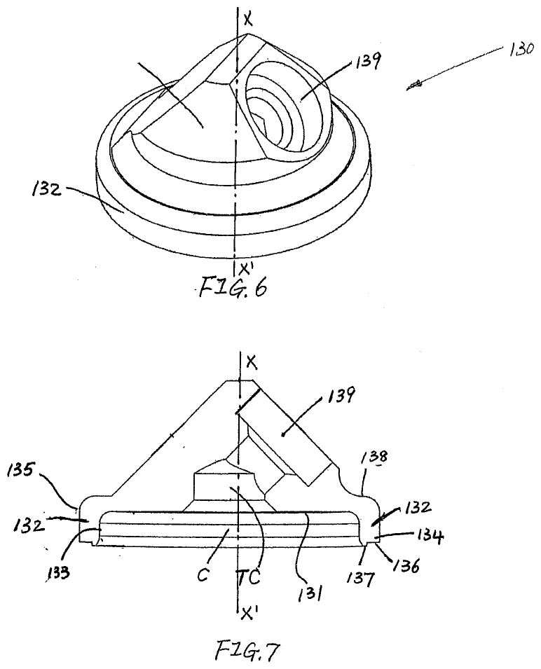

As shown in FIGS. 6 and 7, the damper cover 130 includes a substantially cylindrical wall 132, which is substantially co-axial with the cylindrical wall 122 of the damper housing 120. The diameter of the cylindrical wall 132 is substantially the same as the diameter of the cylindrical wall 122 of the damper housing 120.

The cylindrical wall 132 has an outer surface 135 and a radially opposite inner surface 133. The damper cover 130 further includes an inner top surface 131, which is substantially parallel to the top surface 112 of the pump body 110. The inner top surface 131 and the inner surface 135 together define a cover cavity C, which is a part of the damper receiving space S.

The cylindrical wall 132 includes a mounting flange 134 at the lowest end of the wall. The mounting flange 134 has a bottom engaging surface 136 for mechanically engaging and bonding the top engaging surface 124 of the damper housing 120. For example, the bottom engaging surface 136 and the top engaging surface 124 can be further welded to each other. In addition, the mounting flange 134 further includes a shoulder 137 for properly orientating the damper cover 130 with respect to the damper housing 120. In operation, the shoulder 137 engages the inwardly tapered surface 125 of the damper housing 120 to allow the damper cover 130 to be properly centered with respect to the damper housing 120. The shoulder 137 also provide a press-fit feature, which permits pre-assembly of the damper cover 130 to the pump housing 120 prior to welding. The shoulder 137 can also be used as a welding shoulder for the purpose of mitigating thermal exposure to the inside surfaces of the damper receiving space S and for allowing a clean transition for the radial weld of the damper cover 130 to the damper housing 120. At the same time, smooth fluid flow through the damper housing 120 can be maintained. The damper cover 130 further includes a top surface 138 for pressing the damper cover 130 to the damper housing 120.

The damper cover 130 further includes a fuel inlet fitting end 139 for operatively engaging the fuel inlet fitting 150 (shown in FIG. 1). Once the damper cover 130 is assembled to the damper housing 120, the fuel flows from the fuel inlet fitting 150 toward the high-pressure fuel pump damper 140. Specifically, the fuel flows through a top cavity TC into the cover cavity C.

FIG. 8 illustrates a high pressure fuel pump 200 according to another embodiment of the present disclosure. The high pressure fuel pump 200 includes a pump body 210, which has a top surface 212 and a slanted side surface 214. The high pressure fuel pump 200 further includes a damper housing 220 provided on the top surface 212 and a damper cover 230 coupled to the damper housing 220 through engaging and mating structures similar or same to those of the high pressure fuel pump 100. The pump body 210, the damper housing 220 and the damper cover 230 together define a damper receiving space, in which a fluid pressure damper can be contained. The high pressure fuel pump 200 also includes a fuel inlet fitting 250, which is provided upstream of the fuel circuit ad can be pressed and/or mechanically bonded to the damper cover 230. The inlet fuel fitting 250 is at an angle with respect to the top surface 212 of the pump body 210. In the shown embodiment, the angle is about 45 degrees. The angle can be in a range of about 0 degrees to about 90 degrees with respect to the top surface 212. For example, the angle can be in a range of about 0 degrees to about 45 degrees. For example, the angle can be in a range of about 46 degrees to about 90 degrees. The high pressure fuel pump 200 further includes a high pressure fuel outlet fitting 260, which is provided on the slanted side surface 214 of the pump body 210. When viewed from a top of the high pressure fuel pump 200 in the direction of the axis XX′, the fuel inlet fitting 250 and the high pressure fuel out let fitting 260 forms an angle of about 0 degrees circumferentially with respect to the axis XX′. The angle formed by the fuel inlet fitting 250 and the high pressure fuel outlet fitting 260 can be in a range of about 0 degrees to about 360 degrees circumferentially with respect to the axis XX′. For example, the pump body 210 (including the top surface 212 and the slanted side surface 214) and the high pressure fuel fitting 260 can be similar or the same to those of a known pump. The fuel inlet fitting 250 of this embodiment is a quick connect style fuel inlet fitting.

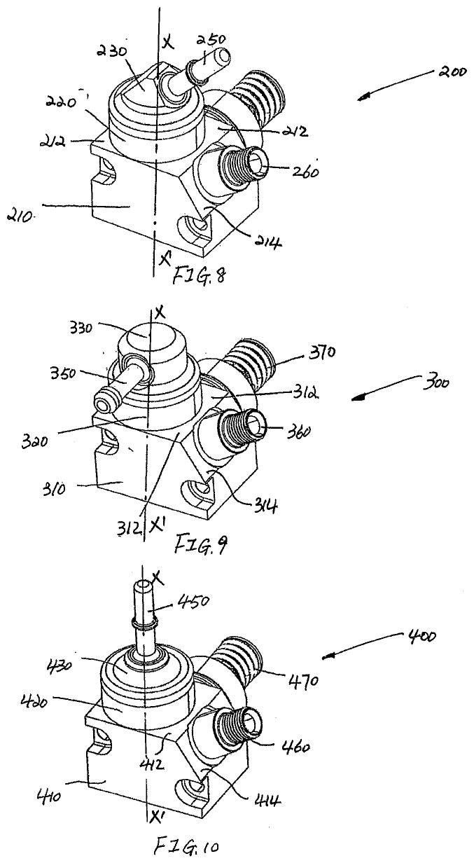

FIG. 9 illustrates a high pressure fuel pump 300 according to yet another embodiment of the present disclosure. The high pressure fuel pump 300 includes a pump body 310, which has a top surface 312 and a slanted side surface 314. The high pressure fuel pump 300 further includes a damper housing 320 provided on the top surface 312 and a damper cover 330 coupled to the damper housing 320 through engaging and mating structures similar or same to those of the high pressure fuel pump 100. The pump body 310, the damper housing 320 and the damper cover 330 together define a damper receiving space, in which a fluid pressure damper can be contained. The high pressure fuel pump 300 also includes a fuel inlet fitting 350, which is provided upstream of the fuel circuit ad can be pressed and/or mechanically bonded to the damper cover 330. The inlet fuel fitting 350 is at an angle with respect to the top surface 312 of the pump body 310. In the shown embodiment, the angle is about 0 degrees, or parallel to surface 312. The angle can be in a range of about 0 degrees to about 90 degrees with respect to the top surface 312. For example, the angle can be in a range of about 0 degrees to about 45 degrees. For example, the angle can be in a range of about 46 degrees to about 90 degrees. The high pressure fuel pump 300 further includes a high pressure fuel outlet fitting 360, which is provided on the slanted side surface 314 of the pump body 310. When viewed from a top of the high pressure fuel pump 300 in the direction of the axis XX′, the fuel inlet fitting 350 and the high pressure fuel out let fitting 360 forms an angle of about 90 degrees circumferentially with respect to the axis XX′. The angle formed by the fuel inlet fitting 350 and the high pressure fuel outlet fitting 360 can be in a range of about 0 degrees to about 360 degrees circumferentially with respect to axis XX′. For example, the pump body 310 (including the top surface 312 and the slanted side surface 314) and the high pressure fuel fitting 360 can be similar or the same to those of a known pump. The fuel inlet fitting 350 is of a different specification than the fuel inlet fitting 250. For example, in this embodiment, the fuel inlet fitting 350 is a barb style fuel inlet fitting. In addition, the high pressure fuel pump 300 further includes a plunger spring 370, which has a higher spring rate than that of the plunger spring of the known pumps.

FIG. 10 illustrates a high pressure fuel pump 400 according to yet another embodiment of the present disclosure. The high pressure fuel pump 400 includes a pump body 410, which has a top surface 412 and a slanted side surface 414. The high pressure fuel pump 400 further includes a damper housing 420 provided on the top surface 412 and a damper cover 430 coupled to the damper housing 420 through engaging and mating structures similar or same to those of the high pressure fuel pump 100. The pump body 410, the damper housing 420 and the damper cover 430 together define a damper receiving space, in which a fluid pressure damper can be contained. The high pressure fuel pump 400 also includes a fuel inlet fitting 450, which is provided upstream of the fuel circuit ad can be pressed and/or mechanically bonded to the damper cover 430. The inlet fuel fitting 450 is at an angle with respect to the top surface 412 of the pump body 410. In the shown embodiment, the angle is about 90 degrees. The angle can be in a range of about 0 degrees to about 90 degrees. Stated differently, the fuel inlet fitting 450 is aligned with axis XX′ of the damper housing 420. The high pressure fuel pump 400 further includes a high pressure fuel outlet fitting 460, which is provided on the slanted side surface 414 of the pump body 410. For example, the pump body 410 (including the top surface 412 and the slanted side surface 414) and the high pressure fuel fitting 460 can be similar or the same to those of a known pump. The fuel inlet fitting 450 is a metric quick connect fitting, as opposed to an English quick connect fitting which is used in known pumps. In addition, the high pressure fuel pump 400 further includes a plunger spring 470, which has a higher spring rate than that of the plunger spring of the known pumps.

In the high pressure fuel pumps 200, 300 and 400, the pump body and the high pressure fuel outlet fitting can be the same as the pump body and the high pressure fuel outlet fitting of known pumps. The damper housings and damper covers can be the same as the damper housing 120 and the damper cover 130 of the pump 100, which are different from the known damper housing and damper cover. The fuel inlet fitting 250, 350 and 450 can be customized for different applications of the pumps. Thus, all these embodiments permit the repurposing of an original equipment fuel pump into under-hood engine environments that were not originally intended, by allowing for changes to the fuel inlet specification, orientation and angle as well as the spring rate of the plunger return spring.

The embodiments of the modified high-pressure fuel pump, as described above, are capable of adapting the original equipment high pressure fuel pump to an application and specification not originally intended for the original equipment high pressure fuel pump. The modification of the original equipment fuel pump is specific to the pressure pulsation damper assembly, the low-pressure fuel inlet, and the pump body mounting flange that permits installation and sealing to the new engine application not originally intended for the unmodified fuel pump.

Another aspect of the present disclosure relates to a method of modifying the damper assembly of an original equipment high pressure fuel pump, for allowing re-purposing of the high-pressure fuel pump from the original engine application to a new engine application not previously considered and for allowing modification of the pressure pulsation damper assembly of the original high-pressure fuel pump.

Still another aspect of the present disclosure relates to the methodology of modifying an original equipment high pressure fuel pump, which constitutes the removal of the original equipment damper assembly, the modification of the original equipment fuel pump damper case, the removal of original equipment pulsation damper diaphragm assembly, providing a newly designed damper housing and new low pressure fitting assemblies, assembling the modified original equipment fuel pump to new damper housing assembly, and providing a mounting flange to adapt the pump to the engine and the final modified fuel pump assembly.

The method and device of the present disclosure is specifically targeted for the non-original equipment market, or commonly called the aftermarket, and more specifically the high-performance aftermarket. The method and device of the present disclosure improve the quality, the manufacturing and minimize the packaging footprint of the damper modification by eliminating seals, threads, fasteners, and excessive manufacturing operations, by simplification as well as employing press and weld methodologies for assembly.

The modified pump presents a completely mechanically sealed system, with higher pressure capabilities and lower manufacturing cost than conventionally fastened and o-ring sealed methods. The modified pump allows for re-purposing of the original pump to applications of which it was not originally intended. The damper housings allow for modification of the original pulsation damping volume and pulsation damping diaphragms in the new modified pump.

According to an embodiment of the present disclosure, the original equipment high pressure fuel pump stainless steel damper housing is removed at a specified dimension from the main pump body and subsequently, the damper housing case is modified with specific edge treatment to provide a high quality internal diameter and edge perpendicular to the internal diameter for the attachment of a new damper housing cover. The original equipment pulsation damper assembly is retained. The new damper housing covers are designed with features developed using computational fluid dynamics to direct and optimize fuel flow through the original equipment damper. The new damper housing design features permit the housing to be pressed into the modified original equipment damper housing case and provides retaining feature to maintain its position and thereby entrap the original equipment pulsation damper. The new damper housing has been designed with features which permit radial welding of the new housing to the modified original equipment damper case. The additional design features of the new damper housing permit the press and weld of an assortment of lower pressure fittings.

While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

What is claimed is:

1. A fuel pump comprising:
a body having a first surface and second surface;
a damper housing provided on the first surface of the body, wherein the damper housing comprises a wall extending from the first surface;
a damper engaged with the first surface;
a high-pressure fuel outlet fitting insertable into an opening of the second surface; and
a damper cover to engage the damper housing in a sealed manner; wherein the damper is entrapped in the space for accommodating a damper, the space defined by the damper housing and the damper cover; wherein the damper cover comprises:
a wall which is substantially co-axial with the wall of the damper housing;
a cavity which forms part of the space for accommodating the damper when the damper cover is engaged with the damper housing; wherein a surface of the damper cover which forms the cavity engages the damper in the space for accommodating the damper; and
an opening for a low-pressure fuel inlet fitting configured to allow fuel to flow from the low-pressure fuel inlet fitting and into the cavity;
wherein said damper is entrapped with the first surface of the body and the surface which forms cavity of the damper cover; and
wherein fuel moves through the low-pressure fuel inlet fitting, is processed by the damper to increase the pressure of the fuel, and is released through the high-pressure fuel outlet fitting.

2. The fuel pump according to claim 1, wherein the damper cover comprises a mounting flange on the wall of the damper cover for mechanically engaging the wall of the damper housing; wherein the mounting flange comprises a shoulder for orienting the damper cover with respect to the damper housing, and the shoulder comprises a press-fit feature.

3. The fuel pump according to claim 1, wherein the damper cover is radially welded to the damper housing.

4. The fuel pump according to claim 2, wherein the damper cover comprises an outer surface for pressing the damper cover to the damper housing.

5. The fuel pump according to claim 2, the damper becomes entrapped in the space for accommodating the damper when the damper cover is press-fit to the damper housing.

6. The fuel pump according to claim 2, wherein the damper cover is radially welded to the damper housing.

7. The fuel pump according to claim 2, wherein the shoulder is configured to be used as a welding shoulder to mitigate thermal exposure to the surfaces of the space for accommodating the damper and for allowing a clean transition for a radial weld of the damper cover to the damper housing.

8. The fuel pump according to claim 1, wherein engagement of the damper cover and the damper housing does not comprise an o-ring or threading.

9. The fuel pump according to claim 1, wherein the fuel pump further comprises a plunger spring.

10. The fuel pump according to claim 1, wherein the shoulder engages a tapered surface of the damper housing wall.

11. The fuel pump according to claim 1, wherein the low-pressure fuel inlet fitting can be pressed and/or mechanically bonded to the opening for a low-pressure fuel inlet fitting.

12. The fuel pump according to claim 1, wherein the low-pressure fuel inlet fitting is at an angle with respect to the top surface of the pump body.

13. The fuel pump according to claim 1, wherein the low-pressure fuel inlet fitting is a metric quick connect fitting.

14. A damper cover for a fuel pump; wherein the fuel pump comprises a damper and a damper housing;
wherein the damper cover is configured to engage with the damper housing to define a space for accommodating the damper;
a wall which is substantially co-axial with a wall of the damper housing;
a mounting flange on the wall for mechanically engaging the damper housing; wherein the mounting flange comprises a shoulder for orienting the damper cover with respect to the damper housing, and the shoulder comprises a press-fit feature;
the damper cover comprises a cavity which forms part of the space for accommodating the damper when the damper cover is engaged with the damper housing;
a surface of the damper cover forming the cavity configured to engage the damper in the space for accommodating the damper when assembled to the damper housing;
a surface for pressing the damper cover onto the damper housing; and
an opening for a low-pressure fuel inlet fitting configured to allow fuel to flow from the low-pressure fuel inlet fitting and into the cavity;
wherein when the damper cover is pressed into the damper housing the damper is entrapped in the space for accommodating the damper.

15. The damper cover according to claim 14, wherein the low-pressure fuel inlet fitting can be pressed and/or mechanically bonded to the opening for a low-pressure fuel inlet fitting.

16. The damper cover according to claim 14, wherein the low-pressure fuel inlet fitting is at angle with respect to the top surface of the pump body.

17. The damper cover according to claim 14, wherein the low-pressure fuel inlet fitting is a metric quick connect fitting.

18. The damper cover according to claim 14, wherein the shoulder is configured to be used as a welding shoulder to mitigate thermal exposure to the surfaces of the space for accommodating the damper and for allowing a clean transition for a radial weld of the damper cover to the damper housing.

19. A method for entrapping a damper in a fuel pump comprising a body comprising
(a) orienting the damper cover according to claim 14 on a damper housing on a surface of the body such that a damper housed is housed in the space for accommodating a damper; wherein the damper housing comprises wall configured for attachment of the damper cover to the damper housing; and said orienting occurs with an inwardly tapered surface of the damper housing and the shoulder of the damper cover; and
(b) press fitting the damper cover into the damper housing to entrap the damper.

20. The method according to claim 19, further comprising radially welding the damper cover to the damper housing.
